(19) United States
(12) Patent Application Publication
(10) Pub. No.: US 2015/0299027 A1
(43) Pub. Date: Oct. 22, 2015

(54) ENERGY-SAVING AND ENVIRONMENT PROTECTIVE METHOD FOR PREPARING GLASS WITH HIGH INTENSITY

(71) Applicant: Dening YANG, Shenzhen, Guangdong (CN)

(72) Inventor: Dening YANG, Shenzhen, Guangdong (CN)

(21) Appl. No.: 13/985,411

(22) PCT Filed: Mar. 15, 2011
(86) PCT No.: PCT/CN11/00412

§ 371 Date: Aug. 14, 2013

(30) Foreign Application Priority Data
Mar. 18, 2010 (CN) 2010101265584.9
Apr. 30, 2010 (CN) 201010160301.2
Oct. 15, 2010 (CN) 201010516800.0

(51) Int. Cl. C03C 3/091; C03B 19/02; C03C 3/064; C03B 27/012; C03C 3/087; C03C 3/062; C03B 9/30; C03B 17/04

(52) U.S. Cl. CPC C03C 3/091; C03B 9/30; C03B 19/02; C03B 17/04; C03B 27/012; C03C 3/087; C03C 3/062; C03C 3/064

(57) ABSTRACT

A glass preparation process and its glass product, comprising the following steps: step 1: the raw materials are prepared for glass manufacturing according to the compositions contained in the said glass such as SiO₂, CaO, MgO, Al₂O₃, Fe₂O₃ and Na₂O; step 2: after the prepared raw materials are measured, they are put into the bulk material pipe or feed bin; step 3: put the formulated raw materials into molten pool to have them melted under the melting temperature of each glass formula and form the liquid glass with preset viscosity, then they are homogenized and clarified and discharge bubbles to form flowing molten mass; step 4: tube-drawing molding process, blowing molding process or compression molding process is selected and adopted for molding.

### BRANCH OF TECHNOLOGY

The present invention relates to A preparation process for the glass which features high strength, energy saving, environmental protection and low viscosity, and specifically relates to preset and indispensable compositions with practical vale and in a special scope such as Al₂O₃, Na₂O, Fe₂O₃, SiO₂, CaO, MgO or TiO₂ and BaO and the innovative technical solutions for the compositions whose special ratios are preset among SiO₂, CaO and MgO; it has overcome the technical prejudice of all conventional technical prejudices that that a lot of sodium or boron composition must be used to form the fluxing composition; it can produce unexpected and new fluxing function or eutectic function as well as the strength increased by 1.3 times under the premise of energy saving, environmental protection, high-quality control and resource saving, it can also produce new product properties, new applications and functions, discovering and revealing a preparation process for the glass which features high strength, energy saving, environmental protection and low viscosity.

### BACKGROUND ART

When blowing, compression or tube drawing molding processes are adopted to process the abnormal glass products such as solar glass tube of solar water heater, medical and industrial glass tubes, insulator for power grid, the tube, cup, plate, bottle, jar and abnormal glass products for daily, industrial, lamp, electric and chemical use, they have significant defects in production process formula, there is a technical prejudice that a large proportion of Na₂O or B₂O₃ are used to melt the composition of SiO₂, in particular, the alkali-free boron glass products have significant defects such as non-environmental protection, non-energy saving, high viscosity and temperature properties and weak strength. How to solve the above problems, promote the energy saving, environmental production, good durability, strength and light weight in new application, transport cost saving and energy consumption saving during transport is a significant technical difficulty that is expected to be solved but has not been solved successfully.

### SUMMARY

In view of the above prior art defects and shortcomings, the inventor makes positive research and innovation to overcome the prior art shortcomings and defects based on the practical experience and expertise for years in design and manufacturing of this kind of product; after solving the complex problems in production process, it has discovered and revealed an invention that is related to a ratio change among silicon, calcium and magnesium in technical elements, especially the invention for selecting the composition scope of Al₂O₃, the invention for new product properties in new applications, the invention for omitting the existing technical elements such as boron or sodium composition; the unexpected technical effects are generated; it reveals the preset and indispensable compositions with practical vale and in a special scope such as Al₂O₃, Na₂O, Fe₂O₃, SiO₂, CaO, MgO or TiO₂ and BaO and the innovative technical solutions for the compositions whose special ratios are preset among SiO₂, CaO and MgO; it has overcome the technical prejudice of all conventional technical prejudices that that a lot of sodium or boron composition must be used to form the fluxing composition; it can produce unexpected fluxing function or eutectic function as well as the strength increased by 1.3 times; it can also produce a preparation process for the glass which features high strength, energy saving, environmental protection and low viscosity and technical effects in environmental protection, energy saving and emission reduction etc.

The first embodiment of the present invention provides A preparation process for the glass which features high strength, energy saving, environmental protection and low viscosity, characterized in that: it comprises the following steps:

It comprises the following steps:

Step 1: according to the compositions contained in the said glass such as SiO₂, CaO, MgO, Al₂O₃, Fe₂O₃ and Na₂O, and calculated as per weight percentage, the said glass contains B₂O₃ 0-1%, Na₂O 0.01-14%, Fe₂O₃ 0.01-5%, F₂O 0-1%, MgO 8.1-20.2% and Al₂O₃ 8-30%, wherein the content of SiO₂ is 1.9-4.1 times that of CaO, and the content of CaO is 1.2-1.6 times that of MgO; the raw materials are prepared for glass manufacturing as per the above requirements;

Step 2: place the prepared raw materials into the corresponding containers to make them pass through the conveyor lines of raw materials, after being measured, they are put into the mixing apparatus according to the proportion, after being stirred and mixed, they are put into the bulk material pipe or feed bin;

Step 3: put the formulated raw materials into molten pool, all preset and indispensable compositions in a special scope such as Na₂O, Fe₂O₃, Al₂O₃, SiO₂, CaO, MgO or TiO₂ and BaO and raw materials whose special ratios are preset among SiO₂, CaO and MgO are configured by the said glass formula, they are melted under the melting temperature for each glass formula to form the liquid glass with preset viscosity, then they are homogenized and clarified and discharge bubbles to form flowing molten mass;

Step 4: three options are available:

Option 1, adopt tube-drawing molding process: the melted glass body formed in step 3 is drawn to be glass tube through tube-drawing device, after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

Option 2, adopt blowing molding process: blowing molding process is adopted for the melted glass body formed in step 3, after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

Option 3, adopt compression molding process: after the melted glass body formed in step 3 is divided or cut, they are put into the molds to be compressed and formed, after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

According to a preparation process for the glass which features high strength, energy saving, environmental protection and low viscosity in the first embodiment of the present invention, wherein, calculated as per weight percentage, the content of Al₂O₃ is 8-30%, SiO₂ is 2.0-3.6 times that of CaO, CaO is 1.3-1.49 times that of MgO, the content of Na₂O is 0.01-2%, the content of B₂O₃ is 0-1%, and the content of F₂O is 0-1%; the lower limit of annealing temperature (endothermic peak threshold temperature) of the said flat glass goes between 610° C.-680° C.; when the viscosity is 10^{0.5} Pa·s, the temperature of the said glass is 1,520° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,070° C.-1,230° C.; the flexural strength of the said flat glass is 75-180 Mpa.

According to a preparation process for the glass which features high strength, energy saving, environmental protection and low viscosity in the first embodiment of the present invention, wherein, calculated as per weight percentage, the said glass contains Al₂O₃ 19-30%, SiO₂ is 2.0-3.6 times that of CaO, CaO is 1.3-1.49 times that of MgO, the content of Na₂O is 0.01-2%, the content of B₂O₃ is 0-1%, and the content of F₂O is 0-1%; the lower limit of annealing temperature (endothermic peak threshold temperature) of the said flat glass goes between 610° C.-680° C.; when the viscosity is 10^{0.5} Pa·s, the temperature of the said glass is 1,550° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,080° C.-1,230° C.; the flexural strength of the said flat glass is 130-180 Mpa.

According to a preparation process for the glass which features high strength, energy saving, environmental protection and low viscosity in the first embodiment of the present invention, wherein, calculated as per weight percentage, the content of Al₂O₃ is 8-30%, the content of B₂O₃ is 0-1%, the content of Na₂O is 0.01-2%, and the content of F₂O is 0-1%; the lower limit of annealing temperature (endothermic peak threshold temperature) of the said flat glass goes between 610° C.-710° C.; when the viscosity is 10^{0.5} Pa·s, the temperature of the said glass is 1,500° C.-1,640° C.; when the viscosity is 10¹ Pa·s, the temperature of the said glass is 1,420° C.-1,600° C.; when the viscosity is 10² Pa·s, the temperature of the said glass is 1,270° C.-1,360° C.; when the viscosity is 10³ Pa·s, the temperature of the said glass is 1,070° C.-1,280° C.; the flexural strength of the said flat glass is 90-180 Mpa.

According to a preparation process for the glass which features high strength, energy saving, environmental protection and low viscosity in the first embodiment of the present invention, wherein, calculated as per weight percentage, the content of Al₂O₃ is 19-30%, the content of B₂O₃ is 0-1%, the content of Na₂O is 0.01-2%, and the content of F₂O is 0-1%; the lower limit of annealing temperature (endothermic peak threshold temperature) of the said flat glass goes between 610° C.-710° C.; when the viscosity is 10^{0.5} Pa·s, the temperature of the said glass is 1,510° C.-1,680° C.; when the viscosity is 10¹ Pa·s, the temperature of the said glass is 1,420° C.-1,600° C.; when the viscosity is 10² Pa·s, the temperature of the said glass is 1,270° C.-1,360° C.; when the viscosity is 10³ Pa·s, the temperature of the said glass is 1,160° C.-1,280° C.; the flexural strength of the said flat glass is 120-180 Mpa.

According to a preparation process for the glass which features high strength, energy saving, environmental protection and low viscosity in the first embodiment of the present invention, wherein, calculated as per weight percentage, the content of TiO₂ in the said glass is 0.0003-4.9%.

According to a preparation process for the glass which features high strength, energy saving, environmental protection and low viscosity in the first embodiment of the present invention, wherein, calculated as per weight percentage, the content of Na₂O in the said glass is 0.01-8.8%.

According to a preparation process for the glass which features high strength, energy saving, environmental protection and low viscosity in the first embodiment of the present invention, wherein, calculated as per weight percentage, the content of BaO in the said glass is 0.01-14%.

According to a preparation process for the glass which features high strength, energy saving, environmental protection and low viscosity in the first embodiment of the present invention, wherein, calculated as per weight percentage, the total content of SiO₂, CaO and MgO in the said glass is 51-99.8%.

According to a preparation process for the glass which features high strength, energy saving, environmental protection and low viscosity in the first embodiment of the present invention, wherein, calculated as per weight percentage, in the said glass, the content of CaO is 1.3-1.6 times that of MgO, the content of SiO₂ is 2.0-3.6 times that of CaO, and the content of Al₂O₃ is 19-39%.

According to a preparation process for the glass which features high strength, energy saving, environmental protection and low viscosity in the first embodiment of the present invention, wherein, (1). calculated as per weight percentage, in its product contents: \textcircled{1} MgO is 7-20%, \textcircled{2} the content of CaO is 1.0-1.8 time(s) that of MgO, \textcircled{3} SiO₂ is 2.6-5.6 times that of MgO, \textcircled{4} SiO₂ is 2.2-3.8 times that of CaO, \textcircled{5} Al₂O₃ is 0.1-30%, \textcircled{6} Na₂O is 0-18%, \textcircled{7} BaO is 0-5%; (2). the total content of MgO, CaO and SiO₂ in its product is 51%-100%; (3). the strain point temperature of its product goes between 560° C.-720° C.; (4). the water absorption of its product goes between 0-0.001%.

According to a preparation process for the glass which features high strength, energy saving, environmental protection and low viscosity in the first embodiment of the present invention, wherein, calculated as per weight percentage, the content of Al₂O₃ in the said glass is less than or equal to 30%; when the viscosity is 10^{0.5} Pa·s, the temperature of the said glass is 1,480° C.-1,640° C.; when the viscosity is 10¹ Pa·s, the temperature of the said glass is 1,410° C.-1,600° C.; when the viscosity is 10² Pa·s, the temperature of the said glass is 1,180° C.-1,340° C.; when the viscosity is 10³ Pa·s, the temperature of the said glass is 1,040° C.-1,220° C.; the thickness difference of the said glass is less than 0.3 mm; the water absorption of the said glass goes between 0-0.3%; the strain point temperature of the said glass goes between 560° C.-720° C.; the flexural strength of the said glass is 50-180 MPa; the difference of thermal expansion coefficient of the said glass is 1.0-3.0 ppm between 150° C.-300° C.; the difference of thermal expansion coefficient of the said glass is 1.0-2.8 ppm between 550° C.-600° C.

According to a preparation process for the glass which features high strength, energy saving, environmental protection and low viscosity in the first embodiment of the present invention, wherein, the prepared glass is treated with chemical tempering or thermal tempering again.

According to a preparation process for the glass which features high strength, energy saving, environmental protection and low viscosity in the first embodiment of the present invention, wherein, calculated as per weight, (1). calculated as per weight percentage, in its product contents: \textcircled{1} MgO is 7-20%, \textcircled{2} the content of CaO is 1.0-1.8 time(s) that of MgO, \textcircled{3} SiO₂ is 2.6-5.6 times that of MgO, \textcircled{4} SiO₂ is 2.2-3.8 times that of CaO, \textcircled{5} Al₂O₃ is 0.1-30%, \textcircled{6} Na₂O is 0-18%, \textcircled{7} BaO is 0-5%; (2). the strain point temperature of its product goes between 560° C.-720° C.; (3). the water absorption of its product goes between 0-0.001%; (4). calculated as per weight percentage, the total content of MgO, CaO and SiO₂ in its product is 51%-100%.

According to a preparation process for the glass which features high strength, energy saving, environmental protection and low viscosity in the first embodiment of the present invention, wherein, (1) calculated as per weight percentage, in its product contents: \textcircled{1} the content of CaO is 0.6-2.4 times that of MgO, \textcircled{2} the content of SiO2 is 1.3-5.8 times that of MgO, \textcircled{3} the content of SiO₂ is 1.3-5.8 times that of CaO, \textcircled{4} the content of Al₂O₃ is 0.1-30%, \textcircled{5} the content of Na₂O is 0-18%, \textcircled{6} the content of BaO is 0-20%; (2) the total content of MgO, CaO and SiO₂ in its product is 51%-99.9%; (3) the water absorption of its product goes between 0-0.001%.

According to a preparation process for the glass which features high strength, energy saving, environmental protection and low viscosity in the first embodiment of the present invention, wherein, (1). calculated as per weight percentage, in its product contents: \textcircled{1} the content of MgO is 7-20%, \textcircled{2} the content of CaO is 1.0-1.8 time(s) that of MgO, \textcircled{3} the content of SiO₂ is 2.6-5.6 times that of MgO, \textcircled{4} the content of SiO₂ is 2.2-3.8 times that of CaO, \textcircled{5} the content of Al₂O₃ is 0.1-30%, \textcircled{6} the content of Na₂O is 0-18%, \textcircled{7} the content of BaO is 0-5%; (2). the strain point temperature of its product goes between 560° C.-720° C.; (3). the water absorption of its product goes between 0-0.001%; (4). calculated as per weight percentage, the total content of MgO, CaO and SiO₂ in its product is 51%-99.9%.

According to a preparation process for the glass which features high strength, energy saving, environmental protection and low viscosity in the first embodiment of the present invention, wherein, calculated as per weight percentage, in its product contents: the content of CaO is 1.15-1.8 times that of MgO.

According to a preparation process for the glass which features high strength, energy saving, environmental protection and low viscosity in the first embodiment of the present invention, wherein, (1) calculated as per weight percentage, in its product contents: \textcircled{1} the content of MgO is 9.1-22%, \textcircled{2} the content of CaO is 0.6-2.0 times that of MgO, \textcircled{3} the content of SiO₂ is 2.8-5.6 times that of MgO, \textcircled{4} the content of SiO₂ is 2.3-3.8 times that of CaO, \textcircled{5} the content of Al₂O₃ is 0.1-30%, \textcircled{6} the content of Na₂O is 0-18%, \textcircled{7} the content of BaO is 0-5%; (2) the strain point temperature of its product goes between 560° C.-720° C.; (3) the water absorption of its product goes between 0-0.001%; (4) calculated as per weight percentage, the total content of MgO, CaO and SiO₂ in its product is 51%-99.9%.

According to a preparation process for the glass which features high strength, energy saving, environmental protection and low viscosity in the first embodiment of the present invention, wherein, calculated as per weight percentage, when the content of Al₂O₃ in its product is 0-3.8%: the melting process temperature is 1,300° C.-1,400° C. at 10¹ Pa·s; the process temperature for clarified and bubble discharge is 1,120° C.-1,260° C. at 10² Pa·s; the forming process temperature is 1,010° C.-1,060° C. at 10³ Pa·s; the flexural strength of its product is up to 60-100 Mpa.

According to a preparation process for the glass which features high strength, energy saving, environmental protection and low viscosity in the first embodiment of the present invention, wherein, calculated as per weight percentage, when the content of Al₂O₃ in its product is 3.8-15%: the melting process temperature is 1,320° C.-1,430° C. at 10¹ Pa·s; the process temperature for clarified and bubble discharge is 1,140° C.-1,290° C. at 10² Pa·s; the forming process temperature is 1,040° C.-1,130° C. at 10³ Pa·s; the flexural strength of its product is up to 80-130 Mpa.

According to a preparation process for the glass which features high strength, energy saving, environmental protection and low viscosity in the first embodiment of the present invention, wherein, calculated as per weight percentage, when the content of Al₂O₃ in its product is 15-23%: the melting process temperature is 1,360° C.-1,550° C. at 10¹ Pa·s; the process temperature for clarified and bubble discharge is 1,250° C.-1,430° C. at 10² Pa·s; the forming process temperature is 1,060° C.-1,200° C. at 10³ Pa·s; the flexural strength of its product is up to 100-180 Mpa.

According to a preparation process for the glass which features high strength, energy saving, environmental protection and low viscosity in the first embodiment of the present invention, wherein, calculated as per weight percentage, in the said glass, the content of SiO₂ is 2.6-5 times that of MgO, and the content of SiO₂ is 2.4-3.4 times that of CaO.

According to a preparation process for the glass which features high strength, energy saving, environmental protection and low viscosity in the first embodiment of the present invention, wherein, calculated as per weight percentage, the content of CaO is 1.0-1.6 time(s) that of MgO, preferentially 1.2-1.5 times;

### DESCRIPTION OF FIGURES

FIG. 1 is a normal section diagram of the glass tube product in the embodiment manufactured by the tube-drawing molding process adopted by a preparation process for the glass which features high strength, energy saving, environmental protection and low viscosity.

FIG. 2 is a process flow diagram of the glass tube in the embodiment prepared by the tube-drawing molding process adopted by a preparation process for the glass which features high strength, energy saving, environmental protection and low viscosity.

FIG. 3 is a normal section diagram of the glass bottle product in the embodiment manufactured by the blowing molding process adopted by a preparation process for the glass which features high strength, energy saving, environmental protection and low viscosity.

FIG. 4 is a process flow diagram of the glass bottle in the embodiment prepared by the blowing molding process adopted by a preparation process for the glass which features high strength, energy saving, environmental protection and low viscosity.

FIG. 5 is a normal section diagram of the glass cup product in the embodiment manufactured by the compression molding process adopted by a preparation process for the glass which features high strength, energy saving, environmental protection and low viscosity.

FIG. 6 is a process flow diagram of the glass cup in the embodiment prepared by the compression molding process adopted by a preparation process for the glass which features high strength, energy saving, environmental protection and low viscosity.

### DESCRIPTION OF FIGURE MARKS

1: indicate a glass tube product which features high strength, energy saving, environmental protection and low viscosity formed by the tube-drawing molding process
2: indicate a glass bottle product which features high strength, energy saving, environmental protection and low viscosity formed by the blowing molding process
3: indicate a glass cup product which features high strength, energy saving, environmental protection and low viscosity formed by the compression molding process

### EMBODIMENTS

### First Embodiment

According to the first embodiment of the present invention, A preparation process for the glass which features high strength, energy saving, environmental protection and low viscosity, it comprises the following steps:

Step 1: according to the compositions contained in the said glass such as SiO₂, CaO, MgO, Al₂O₃, Fe₂O₃ and Na₂O, and calculated as per weight percentage, the said glass contains B₂O₃ 0-1%, Na₂O 0.01-14%, Fe₂O₃ 0.01-5%, F₂O 0-1%, MgO 8.1-20.2% and Al₂O₃ 8-30%, wherein the content of SiO₂ is 1.9-4.1 times that of CaO, and the content of CaO is 1.2-1.6 times that of MgO; the raw materials are prepared for glass manufacturing as per the above requirements;

Step 2: place the prepared raw materials into the corresponding containers to make them pass through the conveyor lines of raw materials; after being measured, they are put into the mixing apparatus according to the proportion; after being stirred and mixed, they are put into the bulk material pipe or feed bin;

Step 3: put the formulated raw materials into molten pool, all preset and indispensable compositions in a special scope such as Na₂O, Fe₂O₃, Al₂O₃, SiO₂, CaO, MgO or TiO₂ and BaO and raw materials whose special ratios are preset among SiO₂, CaO and MgO are configured by the said glass formula; they are melted under the melting temperature for each glass formula to form the liquid glass with preset viscosity, then they are homogenized and clarified and discharge bubbles to form flowing molten mass;

Step 4: three options are available:

Option 1: adopt tube-drawing molding process: the melted glass body formed in step 3 is drawn to be glass tube through tube-drawing device, after being annealed and cooled, the said glass featuring high strength, energy saving, environmental protection and low viscosity is manufactured, the water absorption of the said glass goes between 0-0.3%, and the flexural strength of the said glass is up to 70-180 Mpa;

Option 2: adopt blowing molding process: blowing molding process is adopted for the melted glass body formed in step 3, after being annealed and cooled, the said glass featuring high strength, energy saving, environmental protection and low viscosity is manufactured, the water absorption of the said glass goes between 0-0.3%, and the flexural strength of the said glass is up to 70-180 Mpa;

Option 3: adopt compression molding process: after the melted glass body formed in step 3 is divided or cut, they are put into the molds to be compressed and formed; after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

The following is an introduction to the technical effects for new product properties discovered in the present invention. (Additionally, unless otherwise specified in this specification, the contents of all compositions in the glass are referred to be weight percentage.)

Viscosity Performance

The viscosity of the embodiments of the present invention is measured by THETA high-temperature rotary viscosimeter from USA.

Seen from the embodiments in Tables 1, 2 and 3 and compared with several key viscosity data (in case of 28% Al₂O₃):

(1) Melting temperature: According to the embodiment of the present invention, the temperature of the glass featuring high strength, energy saving, environmental protection and low viscosity is 1540° C.-1620° C. when the viscosity is 10^{0.5} Pa·s; the temperature of the glass featuring high strength, energy saving, environmental protection and low viscosity is 1450° C.-1520° C. when the viscosity is 10¹ Pa·s.

In the prior art, the viscosity of the said alkali-free boron glass products, such as solar glass tubes, cups, plates, tubes, bottles and cans for medical and chemical purposes, as well as lamps, cannot be measured by THETA high-temperature rotary viscosimeter from USA as the melting temperatures at viscosities of 10^{0.5} Pa·s and 10¹ Pa·s are above 1650° C.-1700° C. In particular, the melting temperatures of the conventional soda-lime glass bottles, cups, plates, tubes, etc. (containing only 1% Al₂O₃) can be measured as 1,580° C. at 10^{1.5} Pa·s, 150° C.-300° C. higher than that of the present invention.

From the temperature at 10² Pa·s for clarified and discharges bubble, the temperature for each embodiment is 1,230° C.-1,300° C. when the content of Al₂O₃ in the present invention is within 28%; the temperatures of the above soda-lime glass products with the prior art go between 1,380° C.-1,400° C., and such temperatures for above alkali-free high-boron glass products go between 1500° C.-1550° C., 150° C.-200° C. higher than that of the present invention.

From the temperature under the forming viscosity 10³ Pa·s, the temperature of each embodiment is 1,090° C.-1,160° C. when the content of Al₂O₃ in the present invention is within 28%; the temperature of the above existing soda-lime glass is 1,210° C.-1,250° C., and the temperature of alkali-free high-boron glass such as the above product is up to 1,3080° C.-1320° C.; since the viscosity performance of the present invention is much better, the insiders all know that compared with the production of prior art, fewer bubble defects, fewer slag points, surface smoothness and quality can be controlled.

Strength Performance

The aforesaid existing products such as tube, cup and bottle, glass insulator for power grid and solar water heater contain about 1% or 1-5% Al₂O₃, and their technical solution is not advisably added with too much Al₂O₃, otherwise the production will not be carried out due to high viscosity, and the strength is only about 45-50 MPa as well.

According to the embodiments of the present invention, as stated in the part for viscosity, it can be known that when 20-25% or 25-30% Al₂O₃ is added, the viscosity is lower than that of the prior art, a platform with good scope for technical control is available, and the product of the present invention can be easily up to 100-160 MPa or 130-180 MPa in product strength.

Environmental Performance

For example, now the solar glass tubes, high-temperature glass lamps and medical glasswares all contain 8-15% B₂O₃ in a bid to reduce the melting viscosity temperature and the forming viscosity temperature in particular; the boron-free glass products in the present invention have certain advantages: (1) Since the boron is not added as traditional fluxing material, there is no emission of poison gas from the boron, which is environment friendly; (2) After 18-25% Al₂O₃ is added, the viscosity is easily controlled when compared with the existing alkali-free glass materials, while the strength can be 100-160 MPa or 130-160 MPa.

Cost Performance Reduction

The equipments for boron-free glass product in the technical solution of the present invention can hardly erode the refractory materials in the molten pool due to its boron-free composition, which greatly improves the service life of the equipments by 2-3 times.

The linear characteristics of expansion coefficient are outstanding, and few changes are witnessed at different ranges of temperature;

The expansion coefficient of the glass as set forth in the embodiment of the present invention is determined in accordance with GB/T7320.1-2000.

(1) The conventional technical prejudice is that Al₂O₃ is added to enhance the strain point temperature (the strain point temperature is the lower limit of the annealing temperature for the glass when it is formed); the purpose of having the strain point reached 550° C.-600° C., 600° C.-650° C. or 650° C. above lies in that no more deformation or cracks are found when it is under relatively high temperature, the product is heated or cooled radically; however, the technical solution of the present invention has better linear characteristics of expansion coefficient and produces few abrupt changes over glass viscoelasticity; the difference of thermal expansion coefficient of the said glass is 1.0-3.0 ppm between 150° C.-300° C.; the difference of alkali-free glass is 1-3.0 ppm between 600° C.-650° C. The products with these invention characteristics are not easily cracked and have good safety when being particularly used for new energy resources, medical, lamp and chemical products.

The following are the samples for specific formulas of a glass which features high strength, energy saving, environmental protection and low viscosity so that the technical solution of the present invention can be understood better.

To further describe the technical solution in the embodiments of the present invention, Table 1 has listed the sample formulas and their performances obtained from a preparation process for the glass which features high strength, energy saving, environmental protection and low viscosity as set forth in the embodiments of the present invention.

TABLE 1

| | Sample No. | | | | | | | | | | |
|---|---|---|---|---|---|---|---|---|---|---|---|
| | Sample | Sample | Sample | Sample | Sample | Sample | Sample | Sample | Sample | Sample | Sample |
| | 1 | 2 | 3? | 4? | 5 | 6 | 7 | 8 | 9 | 10 | 11 |
| SiO₂:CaO | About | About | About | About | About | About | About | About | About | About | About |
| | 1.9 | 2.0 | 4.1? | 4.1? | 2.5 | 2.1 | 2.3 | 2.5 | 2.9 | 1.3 | 3.6 |
| CaO:MgO | About | About | About | About | About | About | About | About | About | About | About |
| | 1.2 | 1.6 | 1.2 | 1.6 | 1.4 | 1.4 | 14.5 | 1.4 | 1.4 | 1.3 | 1.2 |
| MgO content | 18.8 | 15.8 | 11.2 | 10.2 | 11.1 | 13.3 | 11.7 | 11.8 | 12 | 11.1 | 11.5 |
| (wt %) | | | | | | | | | | | |
| CaO content | 23 | 24.5 | 13.8 | 16 | 15.2 | 18.5 | 17 | 16.5 | 16.8 | 14.4 | 14 |
| (wt %) | | | | | | | | | | | |
| SiO₂ content | 44.4 | 50 | 56.1 | 65.3 | 38.2 | 39.2 | 39.3 | 41.2 | 48.7 | 47.6 | 50 |
| (wt %) | | | | | | | | | | | |
| Total content | 86.2 | 90.3 | 81.1 | 91.5 | 64.5 | 71 | 68 | 69.5 | 77.5 | 73.1 | 75.5 |
| of SiO₂, CaO | | | | | | | | | | | |
| and MgO | | | | | | | | | | | |
| (wt %) | | | | | | | | | | | |
| Fe₂O₃ content | 0.1 | 0.15 | 0.2 | 0.1 | 0.3 | 0.1 | 0.2 | 0.1 | 0.1 | 1.3 | 1.2 |
| (wt %) | | | | | | | | | | | |
| Al₂O₃ (wt %) | 8.6 | 9 | 12.7? | 8? | 25 | 20 | 30 | 28 | 20 | 23 | 16 |
| Na₂O content | 4.8 | 0.2 | 5 | 0.3 | 6 | 5 | 0.5 | 1 | 1 | 1 | 5 |
| (wt %) | | | | | | | | | | | |
| BaO content | 0.1 | / | 0.8 | / | 1.7 | 1.9 | 0.5 | 0.4 | 0.4 | 1 | 1.3 |
| (wt %) | | | | | | | | | | | |
| B2O3 content | / | / | / | / | / | / | 0.5 | / | / | / | / |
| (wt %) | | | | | | | | | | | |
| TiO2 content | 0.2 | 0.35 | 0.2 | 0.1 | 2.5 | 2 | 0.3 | 1 | 1 | 0.6 | 1 |
| (wt %) | | | | | | | | | | | |
| Flexural | About | About | About | About | About | About | About | About | About | About | About |
| strength | 75-90 | 75-90 | 80-100 | 75-90 | 145-155 | 130-150 | 160-180 | 150-170 | 135-150 | 140-160 | 90-110 |
| (MPa) | | | | | | | | | | | |

It can be measured by calculation but not by high-temperature rotary viscosimeter.

| | Sample No. | | | | | | | | | | |
|---|---|---|---|---|---|---|---|---|---|---|---|
| | Sample | Sample | Sample | Sample | Sample | Sample | Sample | Sample | Sample | Sample | Sample |
| | 1 | 2 | 3 | 4 | 5 | 6 | 7 | 8 | 9 | 10 | 11 |
| Water absorption | 0-0.3% | 0-0.3% | 0-0.3% | 0-0.3% | 0-0.3% | 0-0.3% | 0-0.3% | 0-0.3% | 0-0.3% | 0-0.3% | 0-0.3% |
| Melting process | About | About | About | About | About | About | About | About | About | About | About |
| temperature (° C.) at | 1580 | 1600 | 1580 | 1590 | 1600 | 1560 | 1640 | 1620 | 1560 | 1580 | 1550 |
| 10^{0.5} Pa · s | | | | | | | | | | | |
| Melting process | About | About | About | About | About | About | About | About | About | About | About |
| temperature (° C.) at | 1490 | 1510 | 1500 | 1510 | 1520 | 1530 | 1570 | 1560 | 1490 | 1510 | 1480 |
| 10¹ Pa · s | | | | | | | | | | | |
| Clarification, | About | About | About | About | About | About | About | About | About | About | About |
| bubble discharge | 1285 | 1280 | 1290 | 1290 | 1320 | 1300 | 1350 | 1340 | 1300 | 1305 | 1295 |
| process | | | | | | | | | | | |
| temperature (° C.) at | | | | | | | | | | | |
| 10² Pa · s | | | | | | | | | | | |
| Forming process | About | About | About | About | About | About | About | About | About | About | About |
| temperature (° C.) at | 1130 | 1120 | 1145 | 1130 | 1180 | 1160 | 1220 | 1200 | 1160 | 1170 | 1140 |
| 10³ Pa · s | | | | | | | | | | | |
| Difference value of | About | About | About | About | About | About | About | About | About | About | About |
| expansion | 1.6-2.8 | 1.2-2.5 | 1.6-2.7 | 1.6-2.6 | 1.4-2.7 | 1.7-2.8 | 1.6-2.4 | 1.4-2.8 | 1.2-2.5 | 1.4-2.6 | 1.6-2.7 |
| coefficient at | | | | | | | | | | | |
| 150° C.-300° C. | | | | | | | | | | | |
| (about PPM) | | | | | | | | | | | |
| Difference value of | About | About | About | About | About | About | About | About | About | About | About |
| expansion | 1.4-2.5 | 1.3-2.6 | 1.8-2.8 | 1.6-2.5 | 1.7-2.6 | 1.8-2.3 | 1.9-2.2 | 1.4-2.4 | 1.5-2.1 | 1.8-2.3 | 1.8-2.8 |
| coefficient at | | | | | | | | | | | |
| 550° C.-600° C. | | | | | | | | | | | |
| (about PPM) | | | | | | | | | | | |
| Difference value of | / | / | / | / | / | / | About | About | About | / | / |
| expansion | | | | | | | 1.5-2.4 | 1.7-2.6 | 1.6-2.8 | | |
| coefficient at | | | | | | | | | | | |
| 600° C.-650° C. | | | | | | | | | | | |
| (about PPM) | | | | | | | | | | | |

It cannot be measured by high-temperature rotary viscosimeter, and it is obtained by calculation.

TABLE 2
(Prior Art)

| | Sample No. | | | |
|---|---|---|---|---|
| | Sample 1 existing | Sample 2 existing solar | | |
| | soda-lime glass | and partially medical | | |
| | products such as tube, | boron glass tube, plate | | |
| | cup and bottle | and glass products | Sample 3 | Sample 4 |
| MgO (wt %) | About 5 | About 7 | About 28 | About 7.2 |
| CaO (wt %) | About 6 | About 4 | About 28 | About 13 |
| SiO (wt %) | About 74 | About 68 | About 42 | About 65 |
| Al₂O₃ (wt %) | About 1 | About 11 | 2 | 14.8 |
| Na₂O (wt %) | About 13 | / | / | / |
| B₂O₃ (wt %) | / | About 10 | / | / |
| BaO (wt %) | / | / | / | / |
| K₂O (wt %) | About 1 | / | / | / |
| Fe₂O₃ (wt %) | 0 | 0 | 0 | 0 |
| TiO₂ (wt %) | 0 | 0 | 0 | 0 |
| Melting process | It cannot be measured | It cannot be measured | It cannot be measured | It cannot be measured |
| temperature (° C.) at | by high-temperature | by high-temperature | by high-temperature | by high-temperature |
| 10^{0.5} Pa · s | rotary viscosimeter. | rotary viscosimeter. | rotary viscosimeter. | rotary viscosimeter. |
| Melting process | It cannot be measured | It cannot be measured | About 1580 | About 1520 |
| temperature (° C.) at | by high-temperature | by high-temperature | | |
| 10¹ Pa · s | rotary viscosimeter. | rotary viscosimeter. | | |
| Clarification, bubble | About 1380-1400 | About 1500-1550 | About 1480 | About 1390 |
| discharge process | | | | |
| temperature (° C.) at | | | | |
| 10² Pa · s | | | | |
| Forming process | About 1210-1250 | About 1380-1420 | About 1360 | About 1340 |
| temperature (° C.) at | | | | |
| 10³ Pa · s | | | | |
| Forming process | About 1065-1100 | About 1300-1320 | About 1350-1400 | / |
| temperature (° C.) at | | | | |
| 10^{3.7} Pa · s | | | | |
| Flexural strength (MPa) | About 45 | About 55 | About 50-60 | About 50-60 |
| Difference value of | About 20 | About 15 | About 1.4-2.5 | About 1.3-2.6 |
| expansion coefficient of | | | | |
| glass at 550° C.-600° C. | | | | |
| (about PPM) | | | | |
| Difference value of | / | / | / | / |
| expansion coefficient of | | | | |
| glass at 600° C.-650° C. | | | | |
| (about PPM) | | | | |
| Water absorption | Within 0.3% | Within 0.3% | Within 0.3% | Within 0.3% |

Seen from Table 1, the technical solutions for samples 1-11 in the present invention are all in the scope of embodiment 1, that is, the said glass contains SiO₂, CaO, MgO, Al₂O₃, Fe₂O₃, TiO₂, BaO and Na₂O; calculated as per weight percentage, the said glass contains B₂O₃ 0-3.9%, Na₂O 0.01-14%, Fe₂O₃ 0.01-5%, TiO₂ 0.0003-4.9%, MgO 8.1-20.2% and Al₂O₃ 8-30%, wherein the content of SiO₂ is 1.9-4.1 times that of CaO, and the content of CaO is 1.2-1.6 times that of MgO. Its viscosity is lower than that in Table 2 of the prior art, especially when 20-30% Al₂O₃ is added under the melting temperature (samples 5, 6, 7, 8, 9, 10 in Table 1), and it is added with 10% composition less than all prior arts and comparison examples (samples 1, 2, 3, 4 in Table 2), the melting process temperature will be 150° C.-250° C. lower than the aforesaid at 10^{0.5} Pa·s and 10¹ Pa·s. Moreover, the contents and ratios of silicon, magnesium, calcium, ferrum, titanium and sodium are not in the scope of technical solution of the present invention.

In the same equipment state in the prior art, the technical solution of the present invention can save about 30% energy (the energy will be consumed maximally at the high temperature melting); seen from the comparison between Table 1 and Table 2, the strength can be improved by 2-3 times, and the forming temperature is lowed by over 150° C.-250° C., which will be good for the forming quality control for the product. Seen from Table 1, the samples of the present invention are not added with B₂O₃ in the ten products whose Al₂O₃ content is 28% below, which can fully achieve an environmental effect to treat the special circumstance that the poison gas from boron will be volatilize when the products such as solar glass tube and medical utensil containing 8-12% boron are produced.

Samples 6, 7, 8, 9, 10 in Table 1 have 2.1-2.3 times of ferrum, sodium, magnesium, silicon and calcium as much as the comparison products, the preferred embodiment is that calcium is 1.3-1.5 that of magnesium, and the content of Al₂O₃ is more than 20%, so it can be seen that its viscosity and strength are very good. Samples 1, 2, 3, 4 adopt the upper and lower limits of the ratios of silicon, calcium and magnesium. Seen from each prior art or the comparison samples in Table 2, its technical solution has 2-5or 3-5 differences in the technical solution of the present invention that the compositions include silicon, calcium, magnesium, ferrum and sodium, the content of MgO is 8.1-20.2%, silicon is 1.9-4.1 times that of calcium, and calcium is 1.9-4.1 times that of magnesium. Due to the novel innovation of the technical solution of the present invention, it can generate better technical effects than the prior art such as environmental protection, energy saving, emission reduction and strength, which is good for technical and quality control.

Seen from samples 10 and 11 in Table 1, samples 10 and 11 have better features than the glass in the prior art due to their ferrum content of 1-1.3, high contents of BaO and TiO₂, which will turn into non-transparent brown-yellow or claybank so as to adapt the strength, viscosity temperature and strain point; in the products related to glass cup, plate, bottle, vat and tube, 1-1.5% Fe₂O₃ or a proper amount of BaO, TiO₂, MnO and CoO to generate such colors as ultramarine, blue green, russet brown, reddish brown and black which can be used in, wine, drink and daily bottles, plates, cups with practical values and advanced glass products with deep colors and luxurious decoration values.

### Example 1

Based on the above first embodiment, calculated as per weight percentage, it is limited that the content of Al₂O₃ is 8-30%, SiO₂ is 2.0-3.6 times that of CaO, CaO is 1.3-1.49 times that of MgO, the content of Na₂O is 0.01-2%, the content of B₂O₃ is 0-1%, and the content of F₂O is 0-1%; the lower limit of annealing temperature (endothermic peak threshold temperature) of the said glass goes between 610° C.-680° C.; when the viscosity is 10^{0.5} Pa·s, the temperature of the said glass is 1,520° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,070° C.-1,230° C.; the flexural strength of the said glass is 75-180 Mpa.

### Example 2

Based on the above first embodiment, calculated as per weight percentage, it is limited that the content of Al₂O₃ is 19-30%, SiO₂ is 2.0-3.6 times that of CaO, CaO is 1.3-1.49 times that of MgO, the content of Na₂O is 0.01-2%, the content of B₂O₃ is 0-1%, and the content of F₂O is 0-1%; the lower limit of annealing temperature (endothermic peak threshold temperature) of the said flat glass goes between 610° C.-680° C.; when the viscosity is 10^{0.5} Pa·s, the temperature of the said glass is 1,550° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,080° C.-1,230° C.; the flexural strength of the said flat glass is 130-180 Mpa.

### Example 3

Based on the above first embodiment, calculated as per weight percentage, it is limited that the content of Al₂O₃ is 8-30%, the content of B₂O₃ is 0-1%, the content of Na₂O is 0.01-2%, and the content of F₂O is 0-1%; the lower limit of annealing temperature (endothermic peak threshold temperature) of the said flat glass goes between 610° C.-710° C.; when the viscosity is 10^{0.5} Pa·s, the temperature of the said glass is 1,500° C.-1,640° C.; when the viscosity is 10¹ Pa·s, the temperature of the said glass is 1,420° C.-1,600° C.; when the viscosity is 10² Pa·s, the temperature of the said glass is 1,270° C.-1,360° C.; when the viscosity is 10³ Pa·s, the temperature of the said glass is 1,070° C.-1,280° C.; the flexural strength of the said flat glass is 90-180 Mpa.

### Example 4

Based on the above first embodiment, calculated as per weight percentage, it is limited that the content of Al₂O₃ is 19-30%, the content of B₂O₃ is 0-1%, the content of Na₂O is 0.01-2%, and the content of F₂O is 0-1%; the lower limit of annealing temperature (endothermic peak threshold temperature) of the said flat glass goes between 610° C.-710° C.; when the viscosity is 10^{0.5} Pa·s, the temperature of the said glass is 1,510° C.-1,680; when the viscosity is 10¹ Pa·s, the temperature of the said glass is 1,420° C.-1,600° C.; when the viscosity is 10² Pa·s, the temperature of the said glass is 1,270° C.-1,360° C.; when the viscosity is 10³ Pa·s, the temperature of the said glass is 1,160° C.-1,280° C.; the flexural strength of the said flat glass is 120-180 Mpa.

### Example 5

Based on the above first embodiment, calculated as per weight percentage, it is limited that the said glass contains TiO₂ 0.0003-4.9%.

### Example 2

Based on the above first embodiment, calculated as per weight percentage, it is limited that the said glass contains Na₂O 0.01-8.8% and MgO 10.1-20.2%.

### Example 3

Based on the above first embodiment, calculated as per weight percentage, it is limited that the said glass contains BaO 0.01-14%.

### Example 4

Based on the above first embodiment, calculated as per weight percentage, it is limited that the total content of SiO₂, CaO and MgO in the said glass is 51-99.8%.

### Example 5

Based on the above first embodiment, calculated as per weight percentage, it is limited that in the said glass, the content of CaO is 1.3-1.6 times that of MgO, the content of SiO₂ is 2.0-3.6 times that of CaO, and the content of Al₂O₃ is 19-30%.

### Example 6

Based on the above first embodiment, calculated as per weight percentage, it is limited that (1). in its product content: \textcircled{1} MgO is 7-20%, \textcircled{2} the content of CaO is 1.0-1.8 time(s) that of MgO, \textcircled{3} SiO₂ is 2.6-5.6 times that of MgO, \textcircled{4} SiO₂ is 2.2-3.8 times that of CaO, \textcircled{5} Al₂O₃ is 0.1-30%, \textcircled{6} Na₂O is 0-18%, \textcircled{7} BaO is 0-5%; (2). the total content of MgO, CaO and SiO₂ in its product is 51%-100%; (3). the strain point temperature of its product goes between 560° C.-720° C.; (4). the water absorption of its product goes between 0-0.001%.

### Example 7

Based on the above first embodiment, calculated as per weight percentage, it is limited that the content of Al₂O₃ in the said glass is less than or equal to 30%, when the viscosity is 10^{0.5} Pa·s, the temperature of the said glass is 1,480° C.-1,640° C.; when the viscosity is 10¹ Pa·s, the temperature of the said glass is 1,410° C.-1,600° C.; when the viscosity is 10² Pa·s, the temperature of the said glass is 1,180° C.-1,340° C.; when the viscosity is 10³ Pa·s, the temperature of the said glass is 1,040° C.-1,220° C.; the thickness difference of the said glass is less than 0.3 mm; the water absorption of the said glass goes between 0-0.3%; the strain point temperature of the said glass goes between 560° C.-720° C.; the flexural strength of the said glass is 50-180 MPa; the difference of thermal expansion coefficient of the said glass is 1.0-3.0 ppm between 150° C.-300° C.; the difference of thermal expansion coefficient of the said glass is 1.0-2.8 ppm between 550° C.-600° C.

### Example 8

Based on the above first embodiment, the prepared glass is treated with chemical tempering or thermal tempering again.

### The First Preferential Embodiment

FIG. 1 is a normal section diagram of a glass tube made through the preparation process of a glass featuring high strength, energy saving, environmental protection and low viscosity in the embodiment. Mark 1 of the figure is a glass tube featuring high strength, energy saving, environmental protection and low viscosity; the said glass tube is formed by tube-drawing molding process.

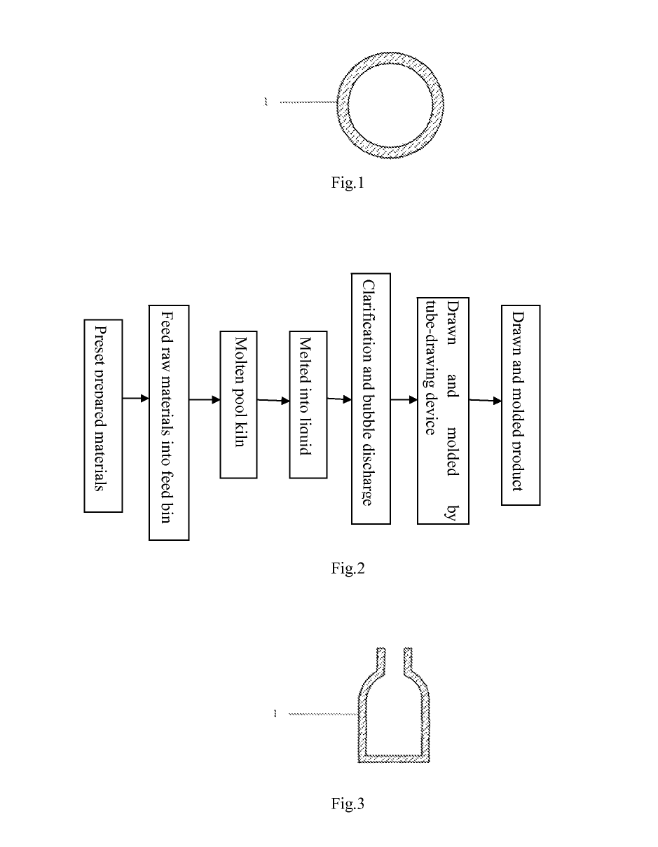

FIG. 2 is a flow diagram of preparation process of a glass tube featuring high strength, energy saving, environmental protection and low viscosity. It can be seen from the figure that its forming process flow is to (1). put the preset and prepared raw materials into the feed bin, (2). convey the raw materials in the feed bin to the molten pool kiln, (3). melt them in the molten pool at preset temperature and discharge the bubbles, and then (4). draw the liquid molten mass with the tube-drawing device to be a glass tube featuring high strength, energy saving, environmental protection and low viscosity in the present invention.

FIG. 3 is a normal section diagram of a glass tube made through the preparation process (blowing molding process is adopted) of a glass featuring high strength, energy saving, environmental protection and low viscosity in the embodiment. Mark 2 of the figure is a glass tube featuring high strength, energy saving, environmental protection and low viscosity, the said glass tube is manufactured by the blowing molding process.

FIG. 4 is a flow diagram of preparation process (blowing molding process is adopted) of a glass tube featuring high strength, energy saving, environmental protection and low viscosity. It can be seen from the figure that its forming process flow is to (1). put the preset and prepared raw materials into the feed bin, (2). convey the raw materials in the feed bin to the molten pool kiln, (3). melt them in the molten pool at preset temperature and discharge the bubbles, and then (4). carry out blowing molding process for the liquid molten mass to form a glass tube featuring high strength, energy saving, environmental protection and low viscosity in the present invention.

FIG. 5 is a normal section diagram of a glass tube made through the preparation process (pressing forming is adopted) of a glass featuring high strength, energy saving, environmental protection and low viscosity in the embodiment. Mark 3 of the figure is a glass tube featuring high strength, energy saving, environmental protection and low viscosity, the said glass tube is manufactured by the compression molding process.

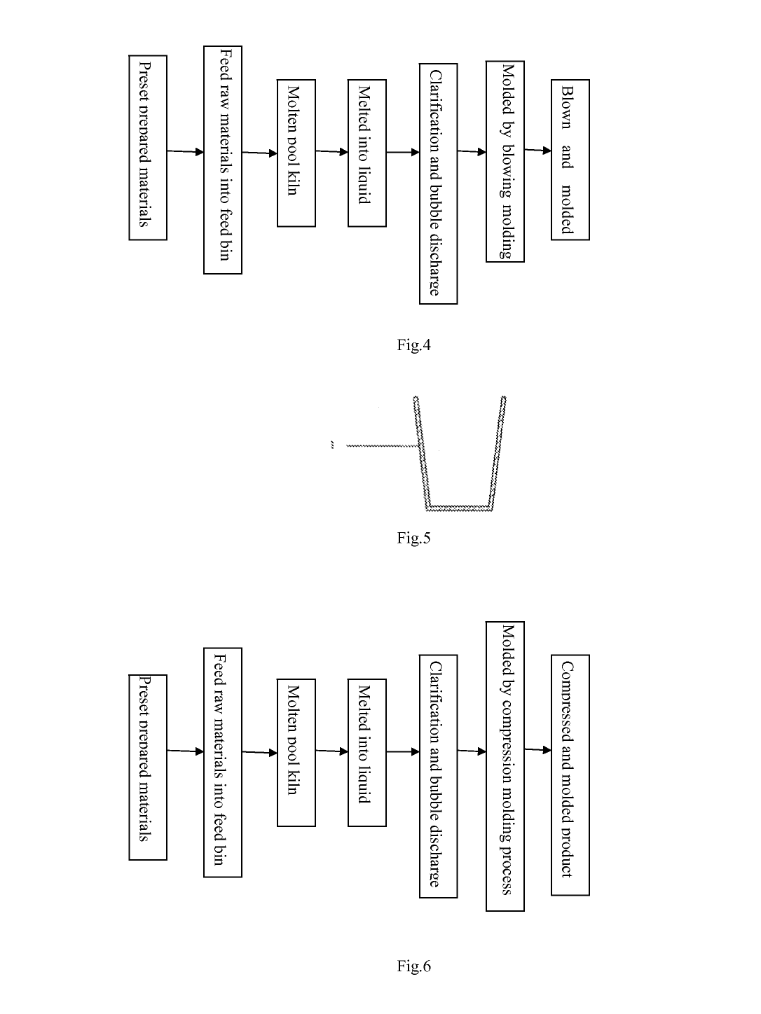

FIG. 6 is a flow diagram of preparation process (pressing forming is adopted) of a glass tube featuring high strength, energy saving, environmental protection and low viscosity. It can be seen from the figure that its forming process flow is to (1). put the preset and prepared raw materials into the feed bin, (2). convey the raw materials in the feed bin to the molten pool kiln, (3). melt them in the molten pool at preset temperature and discharge the bubbles, and then (4). put the liquid molten mass divided or cut in the molds and compress them to form a glass tube featuring high strength, energy saving, environmental protection and low viscosity in the present invention.

A further description of the preparation process (tube-drawing molding process is adopted) of a glass tube featuring high strength, energy saving, environmental protection and low viscosity is given, and its manufacturing process comprises the following steps:

(1). First, prepare the raw materials; the raw material ratio is calculated according to the above first embodiment, its modifications and the compositions of a glass product featuring high strength, energy saving, environmental protection and low viscosity in the examples.

(2). Prepare the production line equipment such as raw material bin, molten pool kiln, and devices required for the tube-drawing molding process.

(3). According to the product flow of the process as shown in FIG. 2, put the preset and prepared raw materials into the feed bin, convey the raw materials in the feed bin to the molten pool kiln, melt them in molten at preset temperature clarify and discharge the bubbles, form the liquid molten mass;

(4). Draw the liquid molten mass with a tube-drawing device to be glass tube; after being annealed and cooled, the said glass tube featuring high strength, energy saving, environmental protection and low viscosity in the present invention is manufactured, and the water absorption of the said glass tube goes between 0-0.3%, the flexural strength of the said glass tube is up to 70-180 Mpa (as shown in FIG. 1).

A further description of the blowing molding process of a glass bottle made by the glass featuring high strength, energy saving, environmental protection and low viscosity is given, and its manufacturing process comprises the following steps:

(1). First, prepare the raw materials; the raw material ratio is calculated according to the above first embodiment, its modifications and the compositions of a glass product featuring high strength, energy saving, environmental protection and low viscosity in the examples.

(2). Prepare the production line equipment such as raw material bin, molten pool kiln, and devices required for the blowing molding process.

(3). According to the product flow of the process as shown in FIG. 2, put the preset and prepared raw materials into the feed bin, convey the raw materials in the feed bin to the molten pool kiln, melt them in molten at preset temperature clarify and discharge the bubbles, form the liquid molten mass;

(4). Based on the blowing molding process, blow the liquid molten mass with a blowing molding device to be glass bottle, after being annealed and cooled, the said glass bottle featuring high strength, energy saving, environmental protection and low viscosity in the present invention is manufactured, and the water absorption of the said glass bottle goes between 0-0.3%, the flexural strength of the said glass bottle is up to 70-180 Mpa (as shown in FIG. 3).

A further description of the press forming of a cup made by the glass featuring high strength, energy saving, environmental protection and low viscosity is given, and its manufacturing process comprises the following steps:

(1). First, prepare the raw materials; the raw material ratio is calculated according to the above first embodiment, its modifications and the compositions of a glass product featuring high strength, energy saving, environmental protection and low viscosity in the examples.

(2). Prepare the production line equipment such as raw material bin, molten pool kiln, and devices required for the compression molding process.

(3). According to the product flow of the process as shown in FIG. 2, put the preset and prepared raw materials into the feed bin, convey the raw materials in the feed bin to the molten pool kiln, melt them in molten at preset temperature clarify and discharge the bubbles, form the liquid molten mass;

(4) Put the liquid molten mass divided or cut in the molds and compress them with a compression molding device, after being annealed and cooled, the said cup featuring high strength, energy saving, environmental protection and low viscosity in the present invention is manufactured, and the water absorption of the said cup goes between 0-0.3%, the flexural strength of the said cup is up to 70-180 Mpa (as shown in FIG. 3).

### APPLICATIONS

Since the above preparation processes of the glass featuring high strength, energy saving, environmental protection and low viscosity as set forth in the embodiments of the present invention can solve the aforesaid three kinds of technical difficulties, they can be applied for production of solar glass tubes for solar water heaters, as well as glass tubes for medical and industrial purposes.

The present invention overcomes the technical prejudice of various traditional fluxing and eutectic compositions, and delivers unexpected technical effects in terms of fluxing and eutectic functions, 1-3 times increase of the product strength, environmental protection, energy saving and emission reduction; it further discloses technical solutions for the tube-drawing molding process, blowing molding process or compression molding process of deformed glass products, such as glass tubes, cups, bottles and plates, as well as glass insulators for power grids and power stations and ornamental glass air brick; all of these have never been revealed or disclosed by the prior art; hence, the technical solutions of the present invention are of novelty.

The technical solutions of the present invention are generally described below based on the characteristics of the preparation process of the glass featuring high strength, energy saving, environmental protection and low viscosity as set forth in the embodiments of the present invention. The technical solutions of the present invention relate to a new product composition, new product properties and preparation technique for such product.

It comprises the following steps:

Step 1: according to the compositions contained in the said glass such as SiO₂, CaO, MgO, Al₂O₃, Fe₂O₃ and Na₂O, and calculated as per weight percentage, the said glass contains B₂O₃ 0-1%, Na₂O 0.01-14%, Fe₂O₃ 0.01-5%, F₂O 0-1%, TiO₂ 0.0003-4.9%, MgO 8.1-20.2% and Al₂O₃ 8-30%, wherein the content of SiO₂ is 1.9-4.1 times that of CaO, and the content of CaO is 1.2-1.6 times that of MgO; the raw materials are prepared for glass manufacturing as per the above requirements;

Step 2: place the prepared raw materials into the corresponding containers to make them pass through the conveyor lines of raw materials, after being measured, they are put into the mixing apparatus according to the proportion, after being stirred and mixed, they are put into the bulk material pipe or feed bin;

Step 3: put the formulated raw materials into molten pool, all preset and indispensable compositions in a special scope such as Na₂O, Fe₂O₃, Al₂O₃, SiO₂, CaO, MgO or TiO₂ and BaO and raw materials whose special ratios are preset among SiO₂, CaO and MgO are configured by the said glass formula; they are melted under the melting temperature for each glass formula to form the liquid glass with preset viscosity, then they are homogenized and clarified and discharge bubbles to form flowing molten mass;

Step 4: three options are available:

Option 1, adopt tube-drawing molding process: the melted glass body formed in step 3 is drawn to be glass tube through tube-drawing device; after being annealed and cooled, the said glass featuring high strength, energy saving, environmental protection and low viscosity is manufactured, the water absorption of the said glass goes between 0-0.3%, and the flexural strength of the said glass is up to 70-180 Mpa;

Option 2, adopt blowing molding process: blowing molding process is adopted for the melted glass body formed in step 3, after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

Option 3, adopt compression molding process: after the melted glass body formed in step 3 is divided or cut, they are put into the molds to be compressed and formed; after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

Deformed bottles, cups, tubes and cans produced by the tube-drawing molding process, blowing molding process or compression molding process in the technical solutions of the present invention have the following characteristics:

First, for all glasses in the prior art, it is an invention for selection of such compositions as aluminum of high content, silicon, calcium, magnesium, ferrum and sodium, and an invention about the changes of ratios among these technical elements such as silicon, calcium and magnesium.

Second, the present invention has disclosed an invention type for the new application of the product transferred from its new properties and generated unexpected effects, that is, with various processing methods for glasses and based on invention of new properties and discoveries of new purposes of glass products, such as low viscosity at different process stages, and the property of eutectic composition consisting of aluminum of high content, silicon, calcium and magnesium, unexpected effects are achieved in terms of high strength, light weight, energy saving and environmental protection by means of high-quality process control at a better viscosity temperature.

Moreover, in the selection of changes over the ratios among the elements of the present invention, its technical solution is as follows: silicon is 2.0-4.1 times that of calcium, and calcium 1.2-1.6 times that of magnesium. All the glass products in the prior art at least has two end values for one element ratio is beyond the scope of the present invention while the glass products in the prior art which adopts tube-drawing molding process, blowing molding process or compression molding process at least has two end values for one element ratio which are beyond the scope of the present invention, that is, the selection of the ratios of the above elements in the present invention is in the scope of the prior art, featuring novelty. In the applications and processes of flat all abnormal products such as bottle, cup, tube and jar produced by adopting tube-drawing molding process, blowing molding process or compression molding process, the following new product properties have been found, and the following unexpected technical effects are generated.

One of the discoveries of new product properties: it has overcome the element omission of Na₂O of soda lime glass caused by the conventional technical prejudice: the soda glass utensil, cup and lamp in the prior art contains about 10-13% sodium which is mainly used for fluxing, especially the fluxing for silicon to control the viscosity at each process stage, however, the technical solutions and new product properties found in the present invention have broken through this technical prejudice, it can be invented according to the change relations among silicon, calcium and magnesium; in the application of the glass, the new product properties is 150° C.-250° C. lower than the viscosity temperature at several process stages for high-sodium flat glass in the prior art when the sodium content is 0-1%, this will generate a lot of melting processes that are good for saving energy and controlling the high-quality products; it can overcome such defects as glass stones and slag points caused by poor melting process as well as bubble ratio caused by poor bubble discharge, especially for the reduction of slag points, stone ratio, bubble ratio, the ratio of forming deformation of nonconforming products, it can provide a good and large process control scope.

In the operation of the prior art and in case of any defects at each process stage, the temperature will be increased for each process stage in operation so as to remove such defects; however, the top of molten pool will be easily collapsed, which greatly shortens its service life. The present invention provides an adjustable scope for the viscosity, which is technically controllable in the control process and has fundamentally solved the technical difficulties that the insiders think that the existing sodium (high-sodium) glass is suffering “short-nature material” (namely “short-nature glass).

(B). One of the discoveries of new product properties: it has overcome the conventional technical prejudice; it produces an invention of omitting a technical element related to “B₂O₃” of an alkali-free boron glass of the glass tube of solar water heater or lamp tube produced by adopting the tube-drawing process: the existing alkali-free boron glass contain no more than 1% sodium. therefore, 8-15% boron is used as a fluxing agent, a technical prejudice exists among some believing in this way, it can achieve the reduction of viscosity temperature of the high-quality flat glass at each process stage, however, the technical solution and the new properties found in the present invention have broken through such technical prejudice, due to the change over the ratio of silicon, calcium and magnesium, and in the new product properties and application, it can be 250° C.-350° C. lower than the viscosity temperature of the product with 8-15% boron in the prior art at several process stages of the flat glass when there is no B₂O₃ (0-1%), this will form a new technical platform for controlling product quality by control process in a bigger scope, for the glass used for solar energy, advanced lamp and medical use, it has high quality requirements and forming precision requirements such as no bubbles, slag points or stones, the finished product rate and excellent product rate, especially for viscosity at bubble discharge, clarification and homogenization process stages and forming and stretching process stages, it has provided a process control scope and a process control platform for boron-free poison gas discharge, energy saving and emission reduction which is much better than the prior art.

(C). One of the discoveries of new product properties: it has overcome a technical prejudice that the viscosity temperature of the conventional glass will be naturally increased radically by adding Al₂O₃, for example, the existing soda-lime glass can only be added with about 1% Al₂O₃ while the existing alkali-free boron-free glass can also be added with about 8% Al₂O₃ to improve the strength, if it is added too much, it will make the viscosity temperature which has been very high at each process stage much higher and fails to achieve the quality goal by controlling the process. The conventional technical prejudice believers hold that the product strength can be improved by adding 25-30% Al₂O₃ under the condition that the controllable process cannot reduce the cost and ensure high quality. However, the technical solutions and the new product properties of the glass found in the present invention have broken through such a technical prejudice, when the present invention does not contain boron, sodium and fluorine (0-1%), and the content of Al₂O₃ is about 3.1%, 16%, 20% or 25% which is a great change, the prior art holds that the viscosity will be increased radically, but the change of the viscosity temperature in the present invention only goes between 30° C.-40° C.; when the content of Al₂O₃ changes between 30%, the viscosity temperature only increases about 40° C.-80° C. (see 11 samples of Table 1 and the sample contrast of Table 2).

Moreover, the viscosity temperature is 100° C.-200° C. lower than the glass product with 13% Na₂O or 8-15% B₂O₃, this proves that the technical solutions of the present invention for the change of the ratio of silicon, calcium and magnesium can produce a new product property when the content of Al₂O₃ is 1-25% or 25-30%, this is a new property for eutectic composition consisting of aluminum, silicon, magnesium and calcium and containing a high content of Al₂O₃, it can produce unexpected effects in high aluminum content but low viscosity temperature, and then an unexpected technical effect in high strength, light weight and less thinness.

In the present invention, the content of Al₂O₃ can be up to 19-28%, and the strength can be up to 140-160 Mpa or 180 Mps, which is 2-3 times as high as the prior art, the viscosity temperature is only 150° C.-250° C. lower than that with the prior art when the content of Al₂O₃ is only 1-25%, therefore, if the viscosity of alkali-free high-boron glass is formed by the technical solution of the present invention, then there will be much room for melting viscosity and strength when the content of Al₂O₃ is raised to be 29-39%. (Note: the flexural strength of the glass in the embodiment of the present specification and invention is cut into pieces with a dimension of 50 mm×50 mm×5 mm and measured in accordance with GB/T3810, 4-2006) B₂O₃ in the alkali-free high-boron glass made with the prior art volatilizes, which will result in uneven compositions, damage the net structure related to Al₂O₃ and thus greatly impact the due strength; this is the important reason why the strength of the alkali-free high-boron glass is relatively poor even though it contains 7-15% Al₂O₃.

Due to a new property for eutectic composition consisting of aluminum, silicon, magnesium and calcium, in addition to high aluminum content and high strength of 90-145 Mpa or 145-180 Mpa, the present invention also features energy saving, lower cost and wider range of process for viscosity temperature, which cannot be achieved by the existing glass production technologies such as the tube-drawing molding process, blowing molding process or compression molding process, it can control melting at the viscosity temperature stage during the melting process, overcome the stones, prevent the slag points that are not melted and control accuracy of the glass during clarification and forming (as the viscosity is lower, the glass product at this process stage will be softer and have a controllable scope, in contrast, as the viscosity is higher, the glass product at this process stage will be harder and have difficulties in controlling the precise of the pulling process, tube-drawing molding process, blowing molding process and compression molding process, and controlling the yield and excellent product rate).

(D). To add 0.01-4% Fe₂O₃ is a combined invention, which can form the new function, save the quality resources and greatly reduce the cost.

Third, since the revealing and discovery of the above new product properties have overcome many of the above prior art prejudices, it produces several unexpected effects and new purposes as below in areas of the glass tubes, cups, plates, bottles and cans for new energy, medical, industrial and chemical purposes, as well as daily use: (1) Technical effects in melting quality, bubble quality, high-precision forming, as well as yield and excellent product rate enhancement due to the property of viscosity temperature; (2) unexpected energy saving effect due to over 200° C. reduction of the viscosity temperature; (3) unexpected technical effect in producing 2-3 times increase of the breaking strength due to massive addition of aluminum to the eutectoid (from 1% to 25-30%); (4) unexpected technical effect in producing 2-3 times thinner glass which saves 2-3 times energy, resource and logistics due to the increase of strength; (5) as an invention with a technical element omitted is adopted, it omits boron to ensure better properties at melting, bubble discharge and forming stages, and improve the breaking strength by adding more Al₂O₃ under the premises that it can better control the quality than the prior art in stones, slag points, bubble rate and forming precision of the alkali-free boron glass in the prior art; unexpectedly, the alkali-free boron glass can be without 8-15% boron, which delivers an environmental effect as there is no emission of poison gas from boron; meanwhile, as there is no production of boron, the molten pool will not be polluted seriously, thus improving equipment efficiency by more than 30%. (6) Compared with the prior art for the glass, the technical solutions of the present invention has the new, unrevealed and undisclosed properties which are not predicted, forecasted and reasoned in advance, it can overcome the conventionally technical prejudice in glass technology and solve the above major issues concerned by people in industry; the technical effect generates the changes over “quality” and “quantity”, it proves that the technical solutions are not obvious but outstanding, having the technical progress and innovativeness. these technical product properties are not predicted and forecasted in advance; the present invention has overcome many technical prejudices and generated the unexpected changes over “quality” and “quantity”, and it proves that the technical solutions are not obvious, having the outstanding substantive features, technical progress and innovativeness.

Major difference between the present invention and the prior art: (I). In the prior art, the glasswares made with the glasses without boron and sodium contain relatively low Al₂O₃ (usually 1-3%) since the technical prejudice that abundant sodium or boron is necessary to form the fluxing composition when more than 3% Al₂O₃ is added, in this way, it is hard to reduce the viscosity temperature and achieve the purpose of quality guarantee, thereby, the strength (no more than 50 MPa usually) of the product is unsatisfactory and cannot reach 70-180 Mp or preferred 120-180 Mpa of the present invention; meanwhile, the firmness, durability and 2-3 times lighter weight as that of the present invention can never be attained. For instance, the prior art SU581097A has disclosed an opacified glass which contains only 1-3% Al₂O₃ and provides a strength of no more than 50 MPa, but the present invention can contain 8-30% Al₂O₃ and features a strength of 70-180 MPa, it contains no boron and only 0.5-2% sodium; the prior art fails to discover and disclose the compositions without sodium and boron (or less than 1%), the property for eutectic composition consisting of aluminum, silicon, magnesium and calcium and containing 8-30% or 19-30% Al₂O₃, new purposes of shaped products at all process stages disclosed by the present invention, viscosity temperatures at the tube-drawing molding process, blowing molding process or compression molding process stage, and other important properties never disclosed. For example: calculated as per weight percentage, the content of Al₂O₃ is 8-30%, SiO₂ is 2.0-3.6 times that of CaO, CaO is 1.3-1.49 times that of MgO, the content of Na₂O is 0.01-2%, the content of B₂O₃ is 0-1%, and the content of F₂O is 0-1%; the lower limit of annealing temperature (endothermic peak threshold temperature) of the said flat glass goes between 610° C.-680° C.; when the viscosity is 10^{0.5} Pa·s, the temperature of the said glass is 1,520° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,070° C.-1,230° C.; the flexural strength of the said flat glass is 75-180 Mpa.

Or calculated as per weight percentage, the content of Al₂O₃ is 19-30%, SiO₂ is 2.0-3.6 times that of CaO, CaO is 1.3-1.49 times that of MgO, the content of Na₂O is 0.01-2% the content of B₂O₃ is 0-1%, and the content of F₂O is 0-1%; the lower limit of annealing temperature (endothermic peak threshold temperature) of the said flat glass goes between 610° C.-680° C.; when the viscosity is 10^{0.5} Pa·s, the temperature of the said glass is 1,500° C.-1,640° C.; when the viscosity is 10¹ Pa·s, the temperature of the said glass is 1,450° C.-1,580° C.; when the viscosity is 10² Pa·s, the temperature of the said glass is 1,210° C.-1,350° C.; when the viscosity is 10³ Pa·s, the temperature of the said glass is 1,080° C.-1,230° C.; the flexural strength of the said flat glass is 130-180 Mpa.

Therefore, under the premises of process viscosity reduction, high-quality melting, bubble discharge and forming, as well as yield and excellent product rate guarantee, several technical effects are unexpectedly in improving firmness and durability by more than 2 times and saving energy, resource and logistics, besides, it enables to make product thinned by 2-3 times while maintaining the strength in the prior art;

(II) With respect to the compositions of the existing alkali-free boron glass solar tubes, lamps and other glass products, the difference is that the fluxing B₂O₃ in the prior art is omitted in the present invention. (1) This can realize a lower viscosity temperature at melting, bubble discharge, forming stages, and better quality control; (2) more Al₂O₃ can be added under the premise of more controllable viscosity; (3) there is no emission of poison gas from boron, which absolutely solves the environmental pollution caused by production of boron glass.

(III) Since the energy consumption is mainly in the high-temperature area, the technical solution can save 30-40% energy by reducing 150° C.-300° C. melting temperature and reduce the emission of CO₂ by 30-40% on the premise of equivalent content of Al₂O₃.

(IIII). The product strength can be improved by 2-3 times due to addition of 15-20% more Al₂O₃ at same viscosity temperature. As a result, it solves the problems of usability, firmness and durability of glass products including tubes, cups, plates and bottles for solar energy, industrial (such as glass insulators for power grids) and medical purposes, as well as daily use; furthermore, it is good for enhancing the solar transmittance as the solar tube is thinned by 1-2 times, thus improving the energy conversion rate remarkably. For the solar tube becomes thinner, it is very suitable for installation on the roofs of less sturdy wooden houses in Europe, America, Australia and Southeast Asia, so as to reduce the weight load of the buildings and ensure safety.

(V) Since the product strength and the weight can be improved and reduced by 2-3 times respectively, the raw materials and costs thereof can be reduced by 2-3 times, while the transportation and logistics costs for inland and ocean transportation can also be lowered.

(VI) Since the glass products can now be manufactured without boron by using same process and platform, which used to contain 8-12% boron, it cuts the emission of poison gas from boron during the production of solar tubes and boron glass tubes for medical, lighting, electrical and chemical industries; finally, a technical solution for non-toxic production is shaped.

The new product properties and unexpected technical effects disclosed in the present invention are technical difficulties which hundreds of enterprises and thousands of technicians engaged in the research of glass tubes, cups, plates, cans and bottles applied in industry, new energy, chemical, electrical, medical and solar industries, as well as glass insulator for power grid have been overcoming for nearly 10-20 years; the present invention also mentions many technical difficulties that are expected to be solved but fail to be solved, obviously, the aforesaid technical effects are not even expected by the insiders.

The above unexpected technical effects are attributed to an invention that changes the ratio of technical elements, an invention about the new product application transferred from its new properties, an invention about element omission, and a combined invention adopting tube-drawing molding process, blowing molding process and compression molding process; after changing of application, some new characteristics are discovered, which have never been revealed or disclosed by the prior art, including new product properties and viscosity temperatures characteristics of the products at every process stages, new features of products and the property of eutectoid consisting of silicon, calcium, magnesium and high content of aluminum, strength characteristics of products, low viscosity temperature and high strength characteristics in the invention with boron and sodium omission and with high content of aluminum. these technical product properties are not predicted and forecasted in advance; the present invention has overcome many technical prejudices and generated the unexpected changes over “quality” and “quantity”, and it proves that the technical solutions are not obvious, having the outstanding substantive features, technical progress and innovativeness. The above statement is only for explaining the preferential embodiments in the present invention, but it is not a limitation for the present invention; any technicians who are familiar with this technology may use the above revealed technical contents, amend or modify the equivalent embodiments with the same changes, a preparation process for the glass which features high strength, energy saving, environmental protection and low viscosity, its preparation methods and glass fiber composite material can be implemented according to different requirements and performances, it can be seen that it is still in the scope of technical solutions of the present invention if it is not separated from the content of technical solutions of the present invention, especially the content of claims no matter any simple amendment, equivalent changes and modifications are made for the above embodiments according to the technical essence of the present invention.

1. (canceled)

2. (canceled)

3. (canceled)

4. (canceled)

5. (canceled)

6. (canceled)

7. (canceled)

8. (canceled)

9. (canceled)

10. A preparation process for the glass which features high strength, energy saving, environmental protection and low viscosity, characterized in that:
It comprises the following steps:
Step 1: according to the compositions contained in the said glass such as SiO₂, CaO, MgO, Al₂O₃, Fe₂O₃ and Na₂O, and calculated as per weight percentage, the said glass contains B₂O₃ 0-1%, Na₂O 0.01-14%, Fe₂O₃ 0.01-5%, F₂O 0, MgO 7-20.2% and Al₂O₃ 8-30%, wherein the content of SiO₂ is 1.9-4.1 times that of CaO, and the content of CaO is 1.0-1.8 time(s) that of MgO; the raw materials are prepared for glass manufacturing as per the above requirements;
Step 2: place the prepared raw materials into the corresponding containers to make them pass through the conveyor lines of raw materials, after being measured, they are put into the mixing apparatus according to the proportion, after being stirred and mixed, they are put into the bulk material pipe or feed bin;
Step 3: put the formulated raw materials into molten pool, all preset and indispensable compositions in a special scope such as Na₂O, Fe₂O₃, Al₂O₃, SiO₂, CaO, MgO or TiO₂ and BaO and raw materials whose special ratios are preset among SiO₂, CaO and MgO are configured by the said glass formula, they are melted under the melting temperature for each glass formula to form the liquid glass with preset viscosity, then they are homogenized and clarified and discharge bubbles to form flowing molten mass;
Step 4: three options are available:
Option 1: adopt tube-drawing molding process: the melted glass body formed in step 3 is drawn to be glass tube through tube-drawing device, after being annealed and cooled, the said glass featuring high strength, energy saving, environmental protection and low viscosity is manufactured, the water absorption of the said glass goes between 0-0.3%, and the flexural strength of the said glass is up to 70-180 Mpa;
Option 2: adopt blowing molding process: blowing molding process is adopted for the melted glass body formed in step 3, after being annealed and cooled, the said glass featuring high strength, energy saving, environmental protection and low viscosity is manufactured, the water absorption of the said glass goes between 0-0.3%, and the flexural strength of the said glass is up to 70-180 Mpa;
Option 3: adopt compression molding process: after the melted glass body formed in step 3 is divided or cut, they are put into the molds to be compressed and formed, after being annealed and cooled, the said glass featuring high strength, energy saving, environmental protection and low viscosity is manufactured, the water absorption of the said glass goes between 0-0.3%, and the flexural strength of the said glass is up to 70-180 Mpa.

11. The glass preparation process as set forth in claim 10, characterized in that:
Calculated as per weight percentage, the content of Al₂O₃ in the said glass is less than or equal to 30%; when the viscosity is 10^{0.5} Pa·s, the temperature of the said glass is 1,480° C.-1,640° C.; when the viscosity is 10¹ Pa·s, the temperature of the said glass is 1,410° C.-1,600° C.; when the viscosity is 10² Pa·s, the temperature of the said glass is 1,180° C.-1,340° C.; when the viscosity is 10³ Pa·s, the temperature of the said glass is 1,040° C.-1,220° C.; the thickness difference of the said glass is less than 0.3 mm; the water absorption of the said glass goes between 0-0.3%; the strain point temperature of the said glass goes between 560° C.-720° C.; the flexural strength of the said glass is 50-180 MPa; the difference of thermal expansion coefficient of the said glass is 1.0-3.0 ppm between 150° C.-300° C.; the difference of thermal expansion coefficient of the said glass is 1.0-2.8 ppm between 550° C.-600° C.

12. The glass preparation process as set forth in claim 10, characterized in that: the prepared glass is treated with chemical tempering or thermal tempering again.

13. A glass product produced with a glass preparation process, characterized in that: according to the compositions contained in the said glass such as SiO₂, CaO, MgO, Al₂O₃, Fe₂O₃ and Na₂O, and calculated as per weight percentage, the said glass contains B₂O₃ 0-1%, Na₂O 0.01-14%, Fe₂O₃ 0.01-5%, F₂O 0%, MgO 7-20.2% and Al₂O₃ 8-30%, wherein the content of SiO₂ is 1.9-4.1 times that of CaO, and the content of CaO is 1.0-1.8 time(s) that of MgO.

14. The glass product produced as set forth in claim 13, characterized in that: calculated as per weight percentage, the said glass contains MgO 8-20.2%.

15. The glass product produced as set forth in claim 13, characterized in that: calculated as per weight percentage, the said glass contains Na₂O 0-0.1%.

16. The glass product produced as set forth in claim 13, characterized in that: calculated as per weight percentage, the said glass contains Al₂O₃ 19-30%, B₂O₃ 0-1%, Na₂O 0.01-2%, and F₂O 0-1%; the lower limit of annealing temperature (endothermic peak threshold temperature) of the said glass goes between 610° C.-710° C.; when the viscosity is 10^{0.5} Pa·s, the temperature of the said glass is 1,510° C.-1,680° C.; when the viscosity is 10¹ Pa·s, the temperature of the said glass is 1,420° C.-1,600° C.; when the viscosity is 10² Pa·s, the temperature of the said glass is 1,270° C.-1,360° C.; when the viscosity is 10³ Pa·s, the temperature of the said glass is 1,160° C.-1,280° C.; the flexural strength of the said glass is 120-180 Mpa.

17. The glass product produced as set forth in claim 13, characterized in that: calculated as per weight percentage, the content of Al₂O₃ in its product is 15-23%.

18. The glass product produced as set forth in claim 13, characterized in that: calculated as per weight percentage, the content of Al₂O₃ in its product is 19-30%.

19. The glass product produced as set forth in claim 13, characterized in that: calculated as per weight percentage, the content of Al₂O₃ in its product is 15-30%.
